(19) United States
(12) Patent Application Publication
(10) Pub. No.: US 2010/0258630 A1
(43) Pub. Date: Oct. 14, 2010

(54) SYSTEMS AND METHODS FOR UPDATING RESOLVED CONTENT OF A MOBILE CODE

(75) Inventors: Michael Shenfield, Richmond Hill (CA); Gaelle Christine Martin-Cocher, Toronto (CA); Clara Margarida Severino, Toronto (CA)

Correspondence Address: Research in Motion Corp/SLW;Attn: Glenda Wolfe, Building 6, Brazos East, Suite 100, 5000 Riverside Drive, Irving, TX, 75039, US

(73) Assignee: Research In Motion Limited, Waterloo (CA)

(21) Appl. No.: 12/479,656

(22) Filed: Jun. 5, 2009

Related U.S. Application Data
(60) Provisional application No. 61/169,300, filed on Apr. 14, 2009.

(51) Int. Cl. G06K 7/10

(52) U.S. Cl. 235/462.15; 235/472.01

(57) ABSTRACT

Various embodiments include systems, methods, data structures, and software to allow a mobile electronic device to update content resolved from a mobile code. For example, a mobile code-reading application executing on a mobile electronic device may receive a mobile code image and decode the mobile code into a data format, the data format including resolved content. The mobile code reading application may detect a content update address field in the data format, the content update address field identifying a content source. A request may be sent to the content source to verify if the resolved content is current and the resolved content or updated content may be presented by a user interface device of the mobile electronic device. In some embodiments, metadata of the resolved content is stored on the mobile electronic device and sent with the request to aid in the verifying. Other embodiments are also described.

### CROSS-REFERENCE TO RELATED APPLICATION

This non-provisional patent application claims the benefit of the filing date of U.S. Provisional Patent Application Ser. No. 61/169,300; filed Apr. 14, 2009; and entitled, “SYSTEMS AND METHODS FOR UPDATING RESOLVED CONTENT OF A MOBILE CODE,” the contents of which is incorporated by reference herein.

### BACKGROUND

Mobile codes, also known as mobile barcodes, are an emerging enabler for encoding large amounts of information within a small matrix-based structure. Mobile electronic devices, such as mobile telephones including cameras, may be used to acquire an image of a one or two dimensional mobile code which may then be processed (hereinafter referred to as resolution, resolving and the like) to extract data embedded therein in a particular format. Mobile codes may be configured in different ways, for example as “direct” mobile codes and “indirect” mobile codes. In the case of resolving a direct mobile code, the data that the mobile electronic device determines from the image may then be resolved and displayed. In the case of indirect mobile code resolution, the mobile code symbology contains an identifier which is or otherwise used by the mobile electronic device sent to a network resource for resolution. Responsive to receiving a communication with the identifier from the mobile electronic device the network resource then replies with content, an action to take on the content, or both. The data resolved (e.g., decoded) from a mobile code is referred to as resolved content.

### COPYRIGHT NOTICE

A portion of the disclosure of this patent document contains material that is subject to copyright protection. The copyright owner has no objection to the facsimile reproduction by anyone of the patent disclosure, as it appears in the Patent and Trademark Office patent files or records, but otherwise reserves all copyright rights whatsoever.

### BRIEF DESCRIPTION OF THE DRAWINGS

FIG. 1 is a system illustration according to an example embodiment;

FIG. 2 is a block flow diagram of a method according to an example embodiment;

FIG. 3 is a block flow diagram of a method according to an example embodiment; and

FIG. 4 is a block diagram of a computing device according to an example embodiment.

### DETAILED DESCRIPTION

Various embodiments herein include at least one of systems, methods, software, and data structures to allow a mobile electronic device to update content resolved from a mobile code. For example, a mobile code reading application executing on a mobile electronic device may receive a mobile code image (e.g., a one or two-dimensional pictogram with encoded data) and decode the image to obtain or resolve data represented therein. The data resolved from the mobile code image, which may be configured in eXtensible Markup Language (XML) format or another language suitable for expressing structured data, may be parsed or otherwise processed to identify an item of content, such as an image. Additionally the resolved data may also include associated metadata (referred to as content metadata or simply metadata) within which a field identifying a content update address such as a Universal Resource Identifier (URI) that may be used to update the content can be included. In another embodiment, the resolved data may include a code ID (e.g., a series of alphanumeric characters such as a URI) to which the same metadata as describe above can be associated with. The code ID may further be sent over a network to a resolution server which returns resolved content (e.g., the content item) associated with the code ID and possibly a set of metadata including the metadata described above to the requesting mobile electronic device.

The resolved content may then be presented by a target application via a user interface device (e.g., speaker, display device, etc.) of the mobile electronic device. The target application may be the mobile code reading application or other application capable of consuming the resolved mobile code. Additional fields may be parsed or otherwise determined from the data that define when or under what circumstances the content is updated or both. In some embodiments, the user of the mobile electronic device may have the option to deny or allow an update of the resolved content, or of the associated metadata (e.g. descriptive text, expiry date).

In some other embodiments, the resolved content may be used by a target application to perform actions not associated with the presentment to the user via user interface device. For example, the resolved content may be used for updating and configuring a mobile electronic device application or the device itself. In some embodiments, the content item may even cause software, such as an application, to be installed or updated on a mobile electronic device.

Mobile codes are useful in many scenarios and more scenarios will emerge as mobile code use increases. One scenario is where the content of a resolved mobile code provides an image of a coupon for a store and a content update address identifying the content source. A content source may be a device that has encoded the data in the mobile image and may be controlled by a person, group, or company that controls the data. For example, store ABC may be the entity that wants to include the coupon described above in a mobile code image. In an embodiment the content source may be a server that manages the mobile code image for store ABC. A target application may also be specified by the decoded mobile code image. For example, by resolving the mobile code, a processor of the mobile electronic device may receive an input of instructions that causes the mobile electronic device to display the coupon image by launching or executing a target application which may be a web browser application or a picture viewing application. Because the image in this example is static, there is the possibility the coupon may have expired. Thus, the originator of the coupon may wish to have a field in the mobile code instructing the mobile electronic device, while resolving the mobile code to check if the coupon (e.g. resolved content) has been updated prior to displaying it to a user. A user of the mobile electronic device may initially see the mobile code image printed on a sign displayed next to a product that is the subject of the coupon and the code may be obtained through a camera of the mobile electronic device. In other embodiments, the mobile code image may be obtained through a store website, an image-based message, an email, or other modes.

Another scenario is in the context of a boarding pass for an airline flight upon which the mobile code may be printed. The mobile code may be acquired or captured through a camera of a mobile electronic device. The mobile code will be resolved into content which provides flight information. In some embodiments, a camera application does not need to save the mobile code as a picture in order to resolve the content. However, the flight information may have changed and thus it may be beneficial to have the content updated prior to displaying it on a mobile electronic device.

Yet another scenario may be a person receiving the mobile code via a multimedia messaging service. If the mobile code has been forwarded many times between different people the resolved content may be out of date.

The embodiments described herein are relevant to these scenarios and others and are described in further detail below with reference to the drawings.

Mobile codes typically include data encoded in a barcode-type pictogram according to a barcoding symbology. Examples of barcoding symbologies include European Article Number/Universal Product Code (EAN/UPC) and variants such as EAN-13, EAN-8, UPC-A and UPC-B; QR and variants such as the Model 2 and Quick Response (QR) 2005 variants; Data Matrix and variants such as the Error Correcting Code (ECC) 20 variant; and Aztec. However, other symbologies including standardized and proprietary barcoding symbologies, and variants thereof, are equally relevant and within the scope of the various embodiments herein and the following claims.

Resolving a mobile code from the pictogram form results in a dataset that is either encoded according to a mobile code format in the direct mode or returned by a server in the indirect mode. This data set is parsable by the mobile code reader or otherwise usable by a target application capable of consuming the resolved mobile code dataset. The format of the dataset may be XML, another markup language, or other format. For example, the dataset typically will include identified segments within which to hold certain data elements, such as content, a content update address, and other data which may include a content expiration date, parameters related to mobile code usage tracking, obtaining additional content, and other data. A data format is the schema in which mobile codes are encoded. Such a data format may be logically represented as follows:

{[...content field ...] [... content update address...][...some additional fields
...] }
where:
content field holds content data;
content update address holds an address of a content source where updated content may be obtained; and
some additional fields is representative of other data items that may be included depending on the configuration of the specific embodiment.

In an embodiment, a dataset is the collection of data that is encoded in the mobile code. The dataset conforms to the data format. Resolved mobile codes, i.e. the datasets, in some embodiments, include at least two types of data elements. The first type is an item of content, such as an image, text, a document, a form, a hyperlink, or other data that may be rendered or otherwise provided to a user of the mobile electronic device via a user interface (e.g., display) of a mobile electronic device. The second type is metadata which can contain a content update address field including an identifier of a content source from which updated content may be obtained, such as by retrieval across a data network or from a local data storage location. In some embodiments, additional elements may include a schedule or frequency of updates.

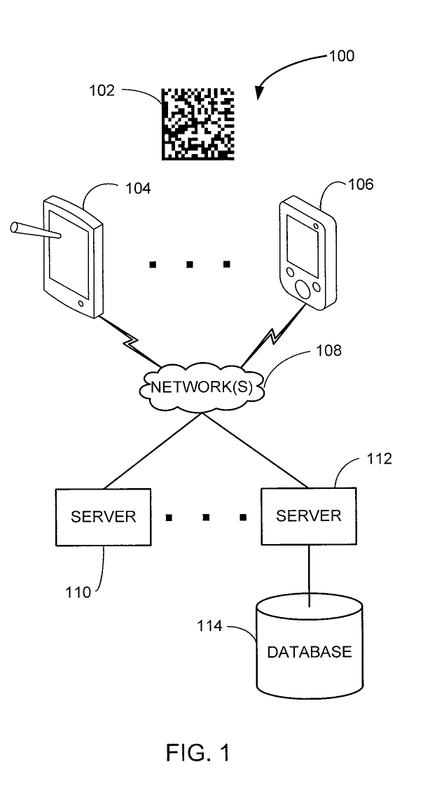

FIG. 1 is a system 100 illustration according to an example embodiment. The system 100 includes mobile electronic devices 104, 106 that communicate over at least one network 108. The system 100 also includes at least one server 110, 112 that communicates over the at least one network 108.

The mobile electronic devices 104, 106 may include one or more network interface devices that are operable to communicate over the at least one network 108. The mobile electronic devices may include, but are not limited to, mobile telephones, portable computers, personal digital assistants, and other devices that may be conveniently carried by a user and provide wireless communication. Mobile telephones include wireless communication devices that have generally been referred to as cell phones. Mobile telephones may include a wide range of communication devices from portable phones with limited functionality beyond voice communication to portable phones capable of providing the functionality of a personal computer. Connections between the mobile electronic devices 104, 106 and the at least one network 108 may include one or more wired or wireless connection possibilities. Examples of wireless connections may include connections to mobile radio networks operating at one or more frequencies according to one or more protocols of such networks (e.g., CDMA, GSM, etc.). The wireless connections may also, or alternatively, include wireless computing network connections, such as connections to IEEE 802.11 type wireless local area networks (e.g., WiFi, WiMAX, WLAN, etc.). The connections may also include shorter range wireless connections to other devices that provide access to the at least one network 108. An example of such a shorter range wireless connection is a Bluetooth wireless connection to another computing device, such as a personal computer, that is connected to the at least one network 108. A further example of such a shorter range wireless connection is a Near Field Communication (NFC) wireless, contactless connection between mobile electronic devices 104, 106, connected to the at least one network 108. Wired connections may include a wired Ethernet connection between a mobile electronic device 104, 106 and the at least one network 108. Other connections may include a wired connection, such as a Universal Serial Bus (USB) wired connection to a USB port of a computing device in communication with the at least one network 108.

The at least one network 108 may include any number of network types, such as one or more of mobile telephone networks, wireless computer networks, and wired computer networks. The at least one network may be interconnected with one or more of the Internet, Local Area Networks (LAN), proprietary networks including content limited to access only by subscribers of particular services, and other networks.

Although two servers 110, 112 are illustrated, there may instead be one server, or more than two servers. The servers 110, 112 may provide one or more of content, services, indirect mobile code resolution (e.g., as a code resolution server), downloadable software, and the like. The servers are accessible by the mobile electronic devices 104, 106 over the at least one network 108. Content provided by the servers 110, 112 may be stored on the respective server, in another location, such as in a database 114, accessible by a server 110, 112 or elsewhere as may be retrieved by the servers 110, 112. Content provided by the servers 110, 112 may also be derived content that may be calculated, assembled, or otherwise determined by the servers 110, 112, such as in response to a query or other request received from a mobile electronic device 104, 106.

The system 100 is typically operable by a mobile electronic device 104, 106 receiving a mobile code image, such as mobile code image 102. As noted above, the mobile code image 102 may be received in several ways, such as from a camera or via a web page, email, a picture-based message, or other electronic modes depending on the capabilities of the mobile electronic device 104, 106. The mobile code image 102 is received by an application executing on the mobile electronic device 104, 106 and resolved to obtain the data encoded therein. The data is then parsed or otherwise processed by the application to obtain the content and additional elements or metadata such as a content update address specifying a content source. In an embodiment, the content source may be a server (e.g., server 112). In an embodiment, an option to update the content manually is displayed on a user interface device. Determining whether or not the content is out of date may be determined by sending a request over a network 108 to the content source. If the content is not current, a download may be initiated that transmits updated content from the content source to the mobile electronic device 104, 106 through a network 108. In an embodiment, resolved content that is not current is content that has been updated at the content source after being received at a mobile electronic device (e.g., a flight has been delayed and there is a new departure time). In other embodiments, not current content may be content that has expired, such as a coupon. In another embodiment, an application executing on a mobile electronic device using the resolved content may have a background process to check for updated content and notify a user if the content is no longer current. A user may choose to update the content or continue using the already resolved content.

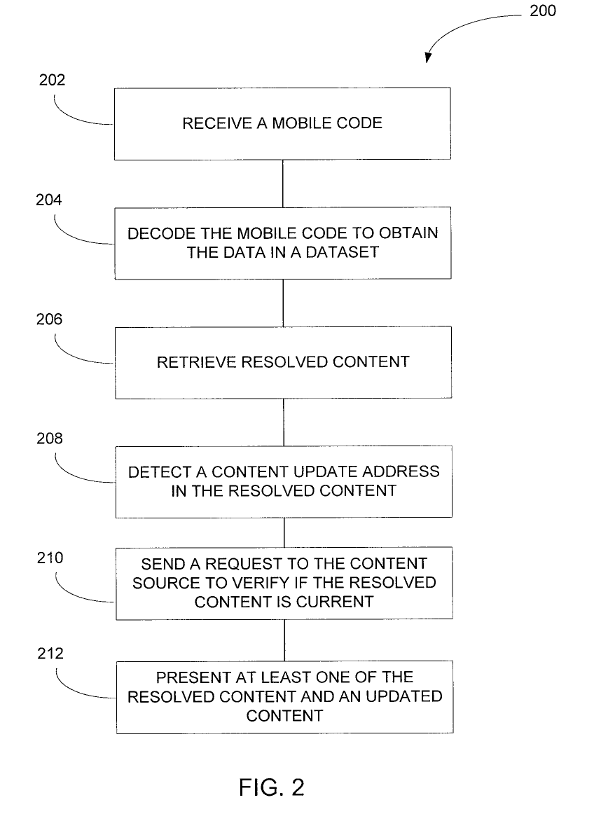

FIG. 2 is a block flow diagram of a method 200 according to an example embodiment. The method 200 is an example of a method that may be performed in whole, or in part, by a mobile electronic device. The example method 200 includes at block 202 receiving within a mobile electronic device, a mobile code image including data encoded therein. Such a mobile electronic device may include at least one processor, at least one memory device, a network interface device, and a user interface (e.g. display device). In some embodiments, the mobile code image is cached on a memory device of the computing device. The example method further includes at block 204 decoding the mobile code image to resolve or otherwise obtain the data from the mobile code image in a data format. In some instances, the data may at least partially include the resolved content. Resolved content may include, but is not limited to, an image, text, a combination of text and images such as a coupon or boarding pass information.

In some embodiments, at block 204 decoding is performed on the at least one processor. At block 206, in an embodiment, the resolved content is retrieved from the data.

At block 208, in an example embodiment, the method includes detecting a content update address field in the dataset, the content update address field identifying a content source. As stated previously, there may be additional fields defined in the dataset which are usable by a mobile electronic device to perform actions on the resolved content. If a content update address field is present, the data included within this field will identify a location where a query or request can be sent to retrieve updated content. In some embodiments, the content update address field is a Universal Resource Identifier (URI), such as a Universal Resource Locator (URL). As one skilled in the art will recognize, similar labels to “content update address” may be used without departing from the example embodiments described herein.

At block 210, in an example embodiment, the method includes sending a request to the content source to verify if the resolved content is current. In an example, the request is sent via the network interface device. The content source may be a server that includes the latest version of the resolved content. For example, if the mobile code image was scanned from a boarding pass, the content source may be a server controlled by the airline issuing the boarding pass.

In some embodiments, the content source (e.g., a server) is responsible for maintaining information related to what version of the resolved content is on a mobile electronic device. For example, upon receiving a request the content source may examine a log of requests received. If the log indicates the resolved content has not changed, a response may be formatted and sent to the mobile electronic device that the resolved content does not need to be updated. However, if the resolved content has been updated, a response may be formatted and sent indicating the resolved content needs to be updated. Additionally or alternatively updated content residing on the server may be sent to the mobile electronic device. Upon receiving the updated content or response, the mobile device may substitute the resolved content with the updated content prior to presenting the updated resolved content. In some instances, the response can be used by the mobile electronic device to appropriately update the content (e.g., change text defining a coupon expiration date so that the stored coupon or corresponding resolved content is removed from the storage) such that sending updated content from the content source to the mobile electronic device is obviated.

In some example embodiments, the content source may determine that only some of the resolved content is not current. In this scenario, a response may be sent indicating a portion of the resolved content needs to be updated and the partially updated content may be sent to the mobile electronic device. The mobile electronic device may substitute a portion of the resolved content with the corresponding updated content prior to presenting the updated resolved content. In further examples, the content source may also respond to a request with a response including the current version of resolved content on the server. Under this scenario it is possible that the sent updated content is the same as the resolved content.

The request sent in block 210 to the content source to verify if the resolved content is current may be sent more than one time. For example, the request may be sent as specified by a user through selection of a displayed application user interface control. In other embodiments, the request may be sent on a periodic basis, such as hourly, daily, weekly, or other period. In yet further embodiments, the request may be sent upon satisfaction of a rule, such as upon presentment of resolved content of the mobile code, upon start of an application, powering on of a mobile electronic device, or other rule depending on the specific embodiment and configuration of a mobile electronic device. In some embodiments, such a rule may be applicable to a metadata associated with the resolved content, predefined application logic, or some event on the mobile electronic device itself. For example, a rule may specify to check for updated versions of resolved content upon occurrence of an event such as moving out of a home network area (e.g., roaming on a visiting network), change of device locale, entering a different region, country, or other geographic area. Upon satisfaction of such a rule, the update may be downloaded to the mobile electronic device automatically or by prompting a user to accept the download.

At block 212, in an example embodiment, the method includes presenting the resolved content. In some examples the resolved content is presented on the display device of the mobile electronic device.

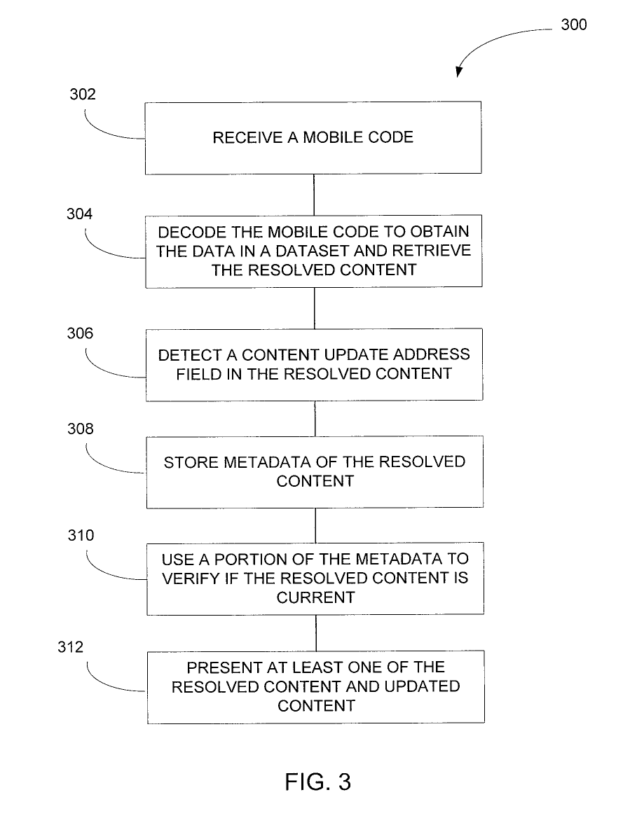

FIG. 3 is a block flow diagram of a method 300 according to an example embodiment. The method 300 is an example of a method that may be performed in whole, or in part, by a mobile electronic device. The example method 300 includes at block 302 receiving, within a mobile electronic device, a mobile code including data encoded therein. Such a mobile electronic device may include at least one processor, at least one memory device, a network interface device, and a user interface (e.g., display device). In some embodiments, at block 302 the mobile code is received. The example method further includes, at block 304, decoding the mobile code to obtain the data in a data format, the data including at least resolved content. In some embodiments, the decoding is performed on, or in cooperation with the at least one processor.

At block 306, in an example embodiment, the method includes detecting a content update address field in the dataset, the content update address field identifying a content source. As stated previously, there may be additional fields defined in the dataset that include data that a mobile electronic device uses to perform actions on the resolved content. If the content update address field is present, the data included within this field will identify a location where a query can be sent to retrieve updated content. In some embodiments, the content update address field is a Universal Resource Identifier (URI), such as a Universal Resource Locator (URL).

At block 308, in an example embodiment, the method includes storing metadata of the resolved content. In some examples, the metadata is stored in at least one memory device of a mobile electronic device. In an embodiment, metadata may be data concerning the resolved content that helps to track if the content is current. For example, a unique content ID of the resolved content may be stored. Other examples include a hash of the resolved content, a timestamp of the resolved content, the time the last request for updated content was made, the time the last updated content was received, and a unique content ID received from the content source.

At block 310, the method includes using at least a portion of the metadata to verify if the resolved content is current. In an example, the request is sent via the network interface device and the request solicits a response indicating if the resolved content needs to be updated. The content source may be a server that includes the latest version of the resolved content. In one scenario, a response may be received at the mobile electronic device that the resolved content needs to be updated. An option to update the resolved content may be presented on the user interface device of the mobile electronic device to update the resolved content. In other example embodiments, a user interface (UI) element is presented on the user interface device giving a user the choice to check for updated content and a request is only sent to the content source if an affirmative selection has made of the UI element.

In other embodiments, the resolved content may be automatically obtained by request from or a push by the content source. In some embodiments, the metadata related to resolved content may reference a target application or one or more configuration settings of applications or a mobile electronic device. In such embodiments, the mobile electronic device may include data representative of an application version, configuration setting state, or other application or device state in the request that solicits the response indicating content is in need of update. If an update is needed, the appropriate updates may be determined at the content source and pushed to or downloaded by the mobile electronic device. The updates may then be applied automatically or under direction of a user, such as in response to a user prompt. Timing and frequency of requests for updated content may be determined based on rules. Such rules may identify events, such as passage of time since a last update check was performed, application start, device start, movement between geographic regions, a detected device or application error, or other event. Occurrence of such events may trigger execution of a rule that will cause the mobile electronic device to solicit the updated content associated with the mobile code. In one embodiment, such rules are predefined according to execution logic of a target application. In other embodiments, such rules are associated with the metadata in the resolved content or provided as a part of resolved content.

In various embodiments, the metadata of the resolved content and the updating management at the content source, as described above, may be combined. For example, the unique content ID of the resolved content may be sent with the request to the content source. In an example embodiment, a unique ID is a series of alphanumeric characters that are randomly generated. A server identified by the content source may be able to search a database for the content ID and determine that no updates are needed for that content ID. Similarly, a hash of the resolved content may be used to help the server quickly determine any potential difference between the resolved content and newer content that may be available.

It should be noted that the update request may be directed to the mobile code resolution server prior to reaching a content source to check for update.

At block 312, in an example embodiment, the method includes presenting by the user interface device, at least one of the resolved content and updated content relative to the verifying. In some examples the resolved content is presented on the user interface device of the mobile electronic device. In other embodiments, the resolved content may not be presented on the user interface device. Instead, the resolved content may include content to facilitate execution of the target application or to modify a state of a mobile electronic device, such as a configuration of the device or an application thereon, or to even cause an application to be installed.

In further example embodiments, additional data may be encoded in the mobile code or associated with the resolved content that instructs a mobile electronic device how and when to update the resolved content. Additional fields may include, but are not limited to, a content expiration field, an update after expiration field, an update frequency field, and an update schedule. These labels are illustrative only and others may be used in example implementations. The content expiration field may indicate a time that after which no updates are allowed or, conversely, that an update should be performed. The update after expiration field may specify whether or not a request to update resolved content is permitted past the original expiration data. For example, a content provider (e.g., Company ABC) may wish to have coupons updated every week and have the option to have expired coupons updated on a mobile electronic device without requiring a user to scan or capture a new mobile code image. In that case, some associated data such as the text describing the coupon may also be updated to reflect the new product the coupon relates to.

The update frequency field may indicate to update at predetermined intervals (e.g., every three days), update a defined number of times, update at most X times over a defined time period, or update indefinitely. It may also define a custom condition for specialized circumstances. For example, if the mobile image code is from a boarding pass, it may be useful to have seat assignment information updated an hour before takeoff. The update schedule may list specific times the resolved content is supposed to update.

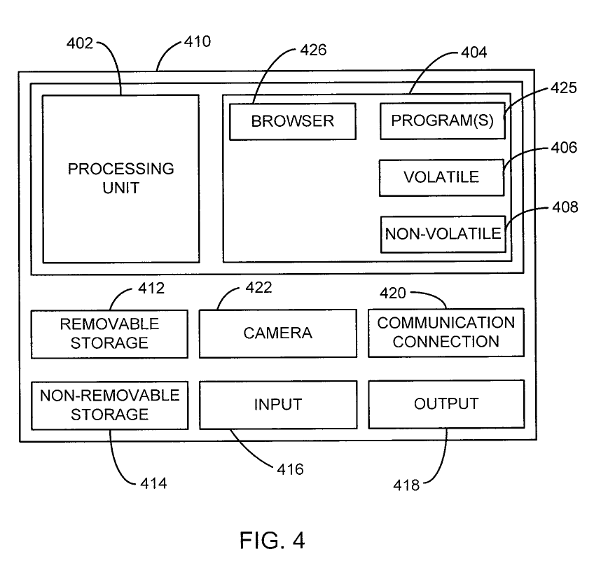

FIG. 4 is a block diagram of a computing device according to an example embodiment. In one embodiment, multiple such computer systems are utilized in a distributed network to implement multiple components in a transaction based environment. An object-oriented, service-oriented, or other architecture may be used to implement such functions and communicate between the multiple systems, devices, and components, such as in a networked computing environment described above with regard to the system 100 of FIG. 1.

One example computing device is in the form of a mobile electronic device 410. The mobile electronic device 410 is an example of the mobile electronic devices 104, 106 described above with regarding FIG. 1. The mobile electronic device 410 may include a processing unit 402, memory 404, removable storage 412, and non-removable storage 414. The processing unit 402 may include one or more processing units or may include one or more multiple-core processing units. Memory 404 may include volatile memory 406 and non-volatile memory 408. Mobile electronic device 410 may include a variety of device-readable media, such as volatile memory 406 and non-volatile memory 408, removable storage 412 and non-removable storage 414. The storage may include random access memory (RAM), read only memory (ROM), erasable programmable read-only memory (EPROM) & electrically erasable programmable read-only memory (EEPROM), flash memory or other memory technologies, or any other medium capable of storing machine-readable instructions and data that may be present in a mobile electronic device. Mobile electronic device 410 may include input 416, output 418, and a communication connection device 420. The mobile electronic device 410, in some embodiments, may also include a camera 422.

The mobile electronic device 410 typically operates in a networked environment using the communication connection device 420 to connect to one or more networks, such as network 108 described above with regard to FIG. 1. Through the communication connection device 420, the mobile electronic device 410 may connect to one or more remote computers. The remote computer may include a personal computer (PC), server (such as servers 110, 112, also described with regard to FIG. 1), router, network PC, a peer device or other common network node, or the like. The communication connection device 420 may connect to various network types that may include a wireless telephone network, a Local Area Network (LAN), a Wide Area Network (WAN), the Internet, a proprietary subscription-based network, or other networks. The mobile electronic device 410 also may include wireless telephone capabilities to provide voice telephone service via a wireless telephone network.

Machine-readable instructions stored on a machine-readable medium are executable by the processing unit 402 of the mobile electronic device 410. The memory 404, removable storage 412, and non-removable storage 414 are some examples of articles including a machine-readable medium. For example, a program 425 with instructions that may be executed by the processing unit 402 to cause the mobile electronic device 410 to perform one or more of the methods described herein may be stored on a machine-readable medium, such as the memory 404. Other programs 425 may also be stored on a machine-readable medium, such as a browser application 426 providing web browsing functionality of the mobile electronic device 410. Further, the programs 425 may include a mobile code reading application that may be operable to extract data from a mobile code image received from camera 422, from a remote server within an email, picture-based message, a web page viewable within the browser application 426, or other source. In some embodiments, the mobile code reading application may be a service application to provide mobile code services, such as a service application included within an operating system that executes upon the mobile electronic device. In other embodiments, the mobile code reading application may be a component of another application operable to present data of and obtained based on data from a mobile code image.

Another embodiment is in the form of a computing device, such as a mobile electronic device. The computing device in this embodiment includes at least one processor, at least one memory device, a network interface device, and a user interface device (e.g., display device). Stored in the at least one memory device is a mobile code reading application, a target application, and a camera application. In an example embodiment, the mobile code reading application is an application that is executable to decode mobile codes. For example, the mobile code reading application may be a bar code reader application. The camera application may be used to capture the mobile code image and cache it in the at least one memory device and then the barcode reading application may decode the mobile code image. The target application is an application that is executable to consume content encoded in mobile codes.

In an example embodiment, the mobile code reading application decodes a mobile code image into a dataset, the dataset including resolved content. It further detects a content update address field in the data format, the content update address field identifying a content source. A request may be sent via the network interface device to the content source to verify the resolved content is current. In an example, the target application is executable by the at least one processor to present, on the user interface device, the resolved content or the update menu/option.

In another embodiment a printed medium bearing a mobile code is provided. The mobile code is configured such that, when resolved, the mobile code yields at least one of computer-readable instructions and data for causing a computing device to update content of a resolved mobile code.

It will be readily understood to those skilled in the art that various other changes in the details, material, and arrangements of the parts and method stages which have been described and illustrated in order to explain the nature of the inventive subject matter may be made without departing from the principles and scope of the inventive subject matter as expressed in the subjoined claims.

1. A method for updating resolved content of a mobile code, the method comprising:
decoding a mobile code into a code ID associated with a content item and metadata that specifies a network address for retrieving an updated version of the content item;
communicating, to a server, the code ID for retrieving the content item;
receiving, in response to the communicating, the content item from the server; and
sending a request for an updated version of the content item to the network address.

2. (canceled)

3. (canceled)

4. (canceled)

5. (canceled)

6. A non-transitory computer readable medium storing instructions thereon which cause a mobile electronic device to perform the method of claim 1.

7. A method comprising:
receiving a code ID from a mobile electronic device, the code ID corresponding to a mobile code which was decoded by the mobile electronic device;
sending, to the mobile electronic device, a content item corresponding to the code ID;
receiving a request for an updated version of the content item from the mobile electronic device;
communicating, responsive to the request an updated version of the content item to the mobile electronic device.

8. (canceled)

9. (canceled)

10. (canceled)

11. A non-transitory computer readable medium storing instructions thereon which cause a mobile electronic device to perform the method of claim 7.

12. (canceled)

13. (canceled)

14. (canceled)

15. (canceled)

16. The method of claim 7, wherein the updated version of the content item is related to a portion of the content item.

17. The method of claim 16, herein the communicating causes the mobile electronic device to substitute the updated version of the content item for the portion of the content item such that only current content is presented by the mobile electronic device.

18. A method for updating resolved content of a mobile code, the method comprising:
decoding a mobile code, at a mobile electronic device, into a code ID which corresponds to a content item stored at a server;
communicating the code ID to the server to retrieve the content item;
receiving, in response to the communicating, the content item and metadata that specifies a network address for retrieving an updated version of the content item; and
sending a request to the network address for the updated version of the content item.

19. The method of claim 18 further comprising, after the sending, displaying at least one of the resolved content or the updated version of the content.

20. A non-transitory computer readable medium storing instructions thereon which cause a mobile electronic device to perform the method of claim 18.

21. A method for updating resolved content of a mobile code, the method comprising:
decoding, on a mobile electronic device, a mobile code into content and metadata that specifies an address of a content source from which to retrieve an updated version of the content;
sending a request for updated content to the address of the content; and
displaying the updated content as a replacement for or supplement to the resolved content.

22. A non-transitory computer readable medium storing instructions thereon which cause a mobile electronic device to perform the method of claim 21.
